(19) United States
(12) Patent Application Publication
(10) Pub. No.: US 2017/0352174 A1
(43) Pub. Date: Dec. 7, 2017

(54) METHOD AND SYSTEM FOR VISUAL DATA MANAGEMENT

(71) Applicants: Sergey Anatol'evich GORISHNIY, Rostov-na-Donu (RU); Anatoliy Aleksandrovich KONDRIK, Rostov-na-Donu (RU)

(72) Inventors: Sergey Anatol'evich GORISHNIY, Rostov-na-Donu (RU); Anatoliy Aleksandrovich KONDRIK, Rostov-na-Donu (RU)

(21) Appl. No.: 15/536,757

(22) PCT Filed: Dec. 19, 2014
(86) PCT No.: PCT/RU2014/000958

§ 371 Date: Jun. 16, 2017

(51) Int. Cl. G06T 11/60; G06F 3/0484

(52) U.S. Cl. CPC G06T 11/60; G06F 3/0484

(57) ABSTRACT

The invention describes a system of visual management, which includes universal way to design user interfaces by navigation combining instances of the native forms of representation of constituent entities metadata using a limited set of graphics primitives. The technical result of the invention is a significant increase in the speed of creating user interfaces with application programs by using methods of declarative programming

### TECHNICAL FIELD

The inventions relates to the area of human computer interaction, a system and methods of information visualization and visual data management. More specifically, the invention relates to user interfaces in general, as well as to the structure, internal organization, methods of user interface creation and methods of interaction between a user interface and data in particular.

### BACKGROUND OF THE INVENTION

In a computer system, an interaction of a user with the information data is realized through a visual interface, using the device display the graphics information, and the means of control and input data such as a mouse and a computer keyboard. The data themselves are sourced from a data management system.

For big and complex application tasks, the creation and upgrade of functionally complex data user interfaces becomes a significant problem, which requires high labor and financial investments in order to be solved.

While being integral parts of a general application, a data management system and a user interface for this system, for a number of reasons, traditionally are mutually isolated. Usually, they would be created using different programming tools and technological means, and, furthermore, these integral parts could be (and, as a rule, are) produced by different manufacturers. Aside from that, in a traditional server-client architecture, data and an interface are separated in space and are realized on separate computers linked in a network.

As a result of the mutual isolation, the interaction between an interface and data is effected through various intermediate layers and modules, using a wide range of communication protocols. The creation and testing of a large amount of programming codes, associated with this, significantly slows down application development, and makes the interface component increasingly expensive. Apart from this, procedural modifications are mostly required in a user interface layer, and each modification, even the most trivial, leads to a new application version release. The process of interface development becomes increasingly labor intensive also due to the use of extensive system libraries of visual components with cumbersome universal tools for the management of individual component properties. The need to reduce the cost and time of an interface programming application are behind the present invention.

### SUMMARY OF THE INVENTION

The present invention overcomes the limitations of the prior arts and enables the creation of interfaces with arbitrary complexity by a highly productive method of direct visual development, without the writing of programming code and its compilation. The subject of the invention is the creation of a universal method of visual and non-visual user interface design; where the interfaces are an integral part of a data management system.

In the first aspect of the invention, we reveal a method for a unified association between an interface and data, as well as a method of interface visual design, based on this association, which uses navigational combinations of instances of native representation forms of metadata subjects in a data management system.

A second aspect of the present invention describes a system of visual data management, formed by a data-component combination on the data side and by visual component instances on the interface side, where the interaction between all subjects, inclusive of metadata subjects, is strictly unified and built on a declarative base.

Apart from this, the present invention reveals the advantages of creating of a user interface from the smallest possible set of graphical components, and contains a description of their nomenclature and functional composition.

An important feature of all aspects of the present invention is a declarative mode of their implementation, which allows us to create application interfaces without the writing of programming code in any form, and hence makes these interfaces fully platform independent. It is worth mentioning that the present invention has a practical programming implementation and has been used in the Visual Data rapid application development platform.

These and other features and advantages of the present invention will be clarified in the following description and the formula of the invention.

### DETAILED DESCRIPTION OF THE INVENTION

From the prior art it is known that in the most common case a visual graphical interface is created programmatically, is a multi-window (multi-document) and is realized by a set of instances, derivative from the unified visual components, which are collected in a system library. Thus one part of the instances acts as a passive visual decoration, while the other is interactively linked to information values of the data management system. Even more generally, an external interface to information values of the data management system may also not be visual. For example, a report interface used to print information values, or a file interface used for a file data entry, or file data export. However, even in these cases, a required type interface could be realized following the same principle. This description will be concerned with a visual interactive graphical interface (being the most complicated interface type), however all points are also fully applicable to non-visual interfaces, which are also the subject of the present invention.

From the prior art it is also known that in the most general case, a data management system, realized by a computer, manipulates of machine-readable information values belonging to a certain target subject area of automation.

Let's review the place and the role of data management system subjects, which describe data.

At a conceptual level of abstraction, any subject area is described by a finite set of conceptual entities, and all information values (data) of a subject area are instances, derivatives from these entities and their characteristics. Conceptual entities (data Classes) and characteristics of conceptual entities (class Attributes) are metadata subjects and in their entirety form a data model of a subject area, hereafter referred to as an Application Model. It is important to emphasize that in a data management system the process of data extraction and modification, inclusive of their creation and deletion, is effected only through the referencing of respective metadata subjects by methods of these subjects. Classes and Attributes, comprising the Application Model, in their turn, are user instances, derivative from system entities of a higher level of abstraction—meta-class and meta-attribute respectively—which are the subjects of a data management system meta-model.

Thus three levels could be identified in a data management system:
1. A level of meta-model of the system itself
2. A level of an application metadata
3. A level of final information values

It is important to note though that all listed objects of the first two levels, in a general case, represent a declarative description, which exists in a machine-readable form adjusted for long-term storage. A data management system utilizes declarative subjects in order to use them as a base for the creation of derivative instances of a lower level, and executes this in a unified manner by internal methods.

Let's review metadata subjects from the point of view of their interface aspect.

In a subject area, conceptual entities and their characteristics are imbued with some native form of how humans perceive them and, for homogeneous and single type objects, this form is unified. Thus a numeric or a string value is commonly perceived as text, a logical or media value as an image, an element set as some enumeration of these elements, a set of numbers as a graph, etc. Hereafter these forms of perception will be referred to as visual object representations, and, as a side note, let's point out that a visual representation is a private case of a more general abstract concept of entity representation. Essentially, an entity representation is an implementation of an interface aspect of the entity, which, in its turn, could assume various forms, inclusive of visual, event, print or file.

From the point of view of an interface aspect, it is obvious that a visual user data interaction interface must be formed by visual representations of metadata subjects, used in multiple combinations, defined by the needs of interaction, including in combination with visual components in the design of the interface. Thus the mentioned Representations are instances, derivative from system entities of a higher level of abstraction, such as miscellaneous meta-Representations of the base subjects of a data management system meta-model—meta-class and meta-attribute.

We should assume that different meta-representations of base subjects (which will be reviewed in more details), in their turn, are instances of even more general abstract meta-representation, which defines the main set of entities and characteristics that provide a unified connection between metadata subjects and an interface components, and is the owner of the base method for the implementation of this connection. At the same time it is important to note that meta-representations and their derivative instances belong to the first and the second levels of the aforementioned abstraction levels and represent some declarative description, which exists in a machine-readable format adjusted for long-term storage. A data management system utilizes predefined representations of base subjects in order to use them as a base for the creation of derivative instances of the next level (specific Representations in the interface that is being created) and executes that in a unified manner with no need for any additional code writing.

Let's review special features of the Representations of various metadata subjects. In a most general case and regardless of the interface type (visual, report, file), a separate conceptual entity of a subject area could be regarded from many interface perspectives, where each of these perspectives includes a particular combination of entity characteristics, which together form a specific interface set. One of the consequences of this is the fact that a user Class, as a declarative metadata subject, could posses an arbitrary number of independent Representations of its own. Thus a separate independent class Representation, hereafter referred to as a Class Form, will be formed by an instance of a meta-Class meta-Representation and will include a combination of Representations of the Attributes and Events of the Class. Consequently, a multi-window visual application interface could be formed by, including but not limited to, a totality of various independent Class Forms that describe the subject area of an application.

It should be noted that an independent Class Form could be used as an interface applied to a single Class instance—a data object derivative from the Class, as well as to multiple such object-instances, in a form of their sequential enumeration. In other words, there are two types of a Class Form—an object (unitary) type and an array (enumerable) type; for their creation, for each interface type, a data Meta-Model provides two eponymous meta-Representations of a meta-Class. Thus it is evident that an Array Class Form differs from an Object Form by the fact that it additionally includes a Representation (an instance of a meta-Representation) of a meta-Array—a declarative entity of the data Meta-Model level, associated with an abstract array.

A meta-Array is in possession of system management methods for an arbitrary abstract array, which include but are not limited to a method of array creation, navigation and representation in the form of a selective enumeration of its members etc. Thus an array could be represented by, including but not limited to, a list containing pairs of key-value elements.

As it was mentioned before, a Class Form includes a totality of Representations of the Attribute and Events of the Class. Unlike a class Attribute, an Event is not an instance of the meta-model level, but represents a virtual metadata subject, which exists permanently for each data Class and is intended for the implementation of the interactive aspect of a Class, as a “factory” for derivative data objects. Nonetheless, a visual Representation of a class Event in a Form is a specific instance, derivative from a meta-Representation of yet another, not mentioned earlier, member of a data management system meta-model—meta-Event. Short of reviewing various types of class Events, we emphasize the most essential—a meta-Event has at least one meta-Representation for each functional event type. Thus a representation of a class Event could be associated with a class Form, in which this event is realized (for example, the creation of a data object inclusive of the value assignment to its characteristics-attributes).

The only characteristic of the class Attribute, which uniquely identifies its interface aspect, is the functional type of an Attribute that sets the type of information value derivative from the Attribute and belongs to one of two groups.

The first group is formed by natural real types, such as Numeric, String, Logical, Date, Image etc., which have a native interface representation of their own, expressed in the form of text or image. At the level of a data management system Meta-Model, for each type of an attribute in this group, there is at least one specific specialized Representation.

The second group is formed by the so-called referential (user) types; this group contains all attributes that implement relationships (quantitative interaction) of the Classes. The value of a referential attribute, as a pointer to a data object, the type of which, similarly to the type of the attribute itself, is defined by the identifier of a target relationship Class (recall that each Class is effectively a uniquely identified user type). On the level of a meta-model, for the whole group of referential attributes, there is a number of specialized meta-Representation, each of them corresponding to one of the interface aspects listed below:
1. A meta-representation of an Event, associated with an Array Class Form, which is used to select the target relationship class from a list, and assign the identifier of a data object as a referential attribute value;
2. A meta-representation of an Event, associated with the call to an Object Class Form;
3. A meta-Representation of the proper target relationship Class;
4. A meta-Representation of the enumeration of target Class objects, which is associated with an attribute of reverse reference (on the “one” side of the “many-to-one” relationship).

Let's review the internal structure of meta-Representations in more detail. An abstract meta-Representation, the common ancestor of all other meta-Representations, includes two parts: the definition of an abstract service function, hereinafter referred to as a Data-component, as well as the definition of an interface tuple—a collection of abstract unified instances of Interface components. An abstract Data-component provides a unified association with metadata subjects, and to achieve this includes at least the following characteristics, whose values are specifically expressed in their derivative instances:
1. An identifier of the functional type of a Meta-Model subject.
2. An identifier of the interface type
3. An identifier of the target instance of a metadata subject

An abstract Interface component, as a separate element of the interface tuple, provides a unified connection between a specific example of the system interface component and an instance of the Data-component, for which purpose it includes at least the following characteristics, whose values are specifically expressed by their derivative instances:
1. An identifier of the target instance of a Data-component
2. An identifier of the type of a system interface component
3. An identifier of the derivative instance of a system interface component.

Apart from the aforementioned properties, both the Data-component and the Interface-component provide in their instances a unified connection of the parent-child type, for which purpose they also include a pointer to the parent instance as well as a list of “child” instances. Each private meta-Representation of a specific metadata subject is an instance, derivative from an abstract meta-Representation, in which the part of characteristics, not defined earlier, receives a concrete value. Thus a Data-component fixes in its declarations identifiers of the subject functional type and the interface type, and each Interface component of the tuple—the identifier of a system interface component.

It is to be noted that a subject metadata meta-Representation could include more than one Interface component. In this case, the interface component, while exchanging pointers, utilizes parent-child characteristics and thus one of the components becomes a root component, i.e. it performs the role of the common parent.

For the purposes of the present invention, it is important to emphasize that all meta-Representations of Meta-Model subjects in a data management system, at the time of a user interface initiation, usually already exist in some predefined form. However this does not prevent the creation of additional meta-Representations during the process of interface initialization; this could be triggered by, inclusive but not limited to, an expansion of the system library of interface components.

It is also important to note that a declarative definition of a private meta-Representation contains a set of entities and characteristics providing the connection between a metadata subject and interface components, while its derivative instances of data-components and interface tuples, in the process of an interface creation, realize this connection on the physical level of execution and provide the required behavior, which is based on the predefined unified methods inherited from a private meta-Representation.

Let's review the creation and interaction of Representation instances in more detail. As it was mentioned before, an application interface is formed by the instances of Data-components and Interface-components, derivative from entity meta-Representations, which participated in the creation of this interface.

At any point in the created interface, regardless of its type, the logic of the creation of a new Representation, an instance of a meta-Representation, is strictly unified and is realized by a navigational method. The essence of a navigational method consists of the fact that there must be an explicit connection between an existing and a new Representation; a connection declared on the Application Model level.

Only in this case, the display interface of the information values will be consistent and logically related. For example, information values (Attribute instances) must belong to the same object (Class instance). This means that only the owned Attributes or Events of a Class could be placed on an interface with relation to this Class, while the referential attribute that belongs to this class will be consequently regarded as a different Class; the Attributes and Events of this other Class could be placed with relation to this Class.

The starting point for the process of creation of a meta-Representation instance is an external event triggered by the user's intention to include a new element into the interface. This event will impact some acting instance of the interface component, which will request an instance of a data-receiver, identified by this component; the Data-receiver, in its turn, will request the initial metadata subject associated with the Data-receiver in order to receive the list of subjects (Attributes or Events) that are allowed for placement in this particular spot of the interface with relation to the initial subject. If the aforementioned list is not empty, it will be offered to the user in a visually convenient form of named elements and the user will make his choice. If the selected subject has more than one meta-Representation, then to choose the meta-Representation to be created, the user is presented with an additional selection dialog; otherwise, the only possible choice is used by default. At the same time, if the selected meta-representation is associated with a user Event, which requires the opening of a new Class Form, a dialog for the Class Form selection will be additionally offered. The selection by the user of a specific meta-Representation concludes the dialog, after which a constructor of the selected meta-Representation is launched. The constructor creates declaration-instances, derivative from Data- and Interface-components of its meta-Representation and assigns them with unique personal identifiers, as well as identifiers of the respective initial components that point to the parent component. Apart from this, a Data-component instance receives the identifiers of a selected metadata subject and (optionally) of a Class Form, and an Interface component instance receives the identifier of the Data-component instance.

Thus the created instances fix the chain of mutual pointers: an Interface component->a Data component->a metadata subject, and are integrated into the systems of parent-child relationship that unite the Data component and Interface component declarations into two conditionally mutually independent data structures: a Data-resource and an Interface resource. It is worth pointing out that while, at the data Meta-Model level, a meta-Representation declaration existed as an independent declarative entity, which united the Data- and Interface-components, at the level of an Application Model there is no need to create an instance of a meta-Representation. The fact that derivative instances of Data- and Interface components belong to a particular meta-Representation is fixed in the declarations of these instances as the identifier of a parent meta-Representation.

Thus, short of writing any programming code, exclusively by using inheritance methods and functional properties of the parent-child relationship as well as unified visual selection dialogs (metadata subject, subject representation, class form), it is possible to continue with the construction of the required interface.

Obviously, the starting point of the aforementioned process of interface creation is an open Class Form, which, as an instance of a meta-Class meta-Representation, includes instances of Data- and Interface-components, which are factually the root objects in the parent-child relationship system that forms the content of Data- and Interface-resources of the Class Form. A Class Form is automatically created when the name of a new form is abstractly created in the unified system form selection dialog.

The aforementioned dialog, in its turn, is called when a created (or an existing) class Even Representation, which has the interface Form type (visual, print etc.) predefined on the level of the Event meta-representation, is assigned a Class Form. In other words, when the unified form selection dialog is called, it receives the required interface type, and, respectively, the dialog reflects only the Forms of the indicated type, and, if a Form is created, it will automatically receive the specified type.

In order to organize and manage declarative Class Forms, a data management system uses derivative objects of the ‘Forms’ service data class, which is hidden from the user. Thus, an identifier of the object that stores Form declarations is used as a unique identifier of a Form.

The Forms class predefines attributes, the instances of which in the objects of this Forms class contain all significant characteristics of a Form declaration, such as the Class identifier, the identifier of a class interface type, user Form name, the structured set of Data-component (Data-resource) declarations, the structured set of Interface-component (Interface-resource) declarations. A new object of the Form class is initiated when a new class Form is created in the unified system form selection dialog; this new object specifies the identifiers of the Class and the interface type.

The structured sets of Data- and Interface-component declarations are automatically serialized and stored in a data object, when a new Representation is created in a Form as well as when a Form is closed after being modified.

Let's review the organization of the data exchange between various components of Representation in the process of execution

When a new interface window based on Form declarations is open, this window receives a unique identifier, followed by the extraction of a Data-resource and an Interface-resource from the Forms data object. The Data-resource, marked by the window identifier, remains on the data side, while the Interface resource, also marked by the window identifier, is passed onto the interface side; this is followed by a data exchange between them that is organized in accordance with the following rules. The Data resource components, beginning with the root Data-component, sequentially use stored identifiers of metadata subjects to reference a data model in order to extract the instances (data objects or information values) derivatives of referenced subjects from the data management system. The extraction process is of a navigational character because a subject-instance pair, for which a single extraction is effected, is always uniquely identified.

The information values, extracted in this manner, are stored in a separate data structure, referred to as a Data Selection. Thus each value, stored in the Selection, is marked with a unique identifier of the Data-component, which extracted this value, and each enumeration element is additionally marked with the sequential enumeration number.

The Selection formed in this manner is serialized, marked with an interface window identifier, and passed to the user interface side.

On the interface side, the identifier of a window in a Data Selection is used to reference and initiate a corresponding interface resource. The components of an Interface resource, initiated in such a manner, will sequentially, beginning with the root interface component, start forming the content of an interface window of a respective interface type, while using the stored identifiers of Data-components to extract the information values reflected in the interface from the Data Selection.

In the case of an interactive interface of visual type, any user action affecting interface components (completed data entry or initiation of the event) is worked out as follows. The interface component, initiated by the user, creates a data structure, referred to as an Interface Event, marks the structure with the interface window identifier and the stored Data-component identifier, supplements the structure with the information value entered by the user (if such a value exists) and passes the Interface Event formed in such a manner to the data side.

On the data side, the received Interface Event is passed to the target component of a Data-resource. The Data-component, initiated in such a manner, utilizes, in respect to its stored declarations, the processing method inherited from a meta-Representation, inclusive of the passing of an information value to the associated metadata subject. If required, after the processing of a user event is completed, the Data-component initiates the whole Data-resource to form a new Data Selection referencing the interface. Thus, exclusively with the use of a visual constructor, acting on declarative metadata subject Representations, and a limited set of predefined system methods we can create a multi-window and a multifunctional interface, without traditional programming code writing. Thus, a separate class window is fully described by a declarative Class Form, which, on one side, is the data object, derivative from a service class, and, on the other, the subject of an interface type metadata. From a certain point of view, the declaration of a single data Class (a meta-Class instance), which includes Declaration of class Attributes (instances of the meta-Attribute), could also be a data subject, derivative from some service class—a super-Class.

In order to open multiple windows, we need one initial application window, which contains management tools (buttons or menu elements) that initiate the opening of all the following windows. Such a window could be represented by the Form of the aforementioned Super-class, with relation to which class Representations are placed; where these class Representations have an interactive form of a button (or buttons grouped into a menu), to which the required Forms are assigned with a unified dialog.

Another aspect of the present invention is a progressive method of the organization of a visual component system library. This aspect is closely related with the previous one because Interface components of any visual Representation are instances of components of a system library in a declarative form, which includes, but not limited to, the definition of their private visual characteristics values.

A system library of visual components, from the instances of which a specific user interface is formed, is the base of any system of development and implementation of visual graphical interfaces. The obvious advantage of such a library is the consistency of properties, methods of display and behavior methods for all components included in the library.

A significant disadvantage of the available libraries is their wide range of components. The libraries contain numerous components, inclusive those that are functionally complex, in order to satisfy all possible interface needs of an application task. At the same time, in practice, always and constantly meet such needs, one way or another, but is beyond the possibilities as a single component library, and combinations thereof. These needs have to be satisfied by changing the programming code of standard library components, which leads to new library versions, where the versions could potentially conflict with each other, and is also an expensive and unsafe practice, because in such a case the library itself should be represented in an open form, allowing modifications. As an example, let's review such a relatively uncomplicated and widely used interface component as a visual Button. A Button includes, but is not limited to, a visual Icon and Text. All visual characteristics of a Button, inclusive of its form, color, border as well as the representation, position and composition of the Icon and the Text, are defined and managed in a standard manner. However, in order to add an additional decorative element to the button, we would have to create yet another library component inheriting from a button and to modify the programming code behind this component.

Apart from this, the large amount of library components requires a certain level of familiarity with the specifics of their implementation, use and interaction, which obvious way also creates difficulties in the process of creation of application interfaces.

The administration of visual component properties is also a complicated task resulting from the high number and diversity of the components. The wide variety of the components and their properties leads to the need to use a universal property Inspector as the main visual administration tool; the Inspector displays all properties as a linear enumeration. Thus, with increasing functional complexity of system components, labor intensity of their administration through the Inspector will obviously increase progressively. If for a simple Text component reflecting a simple Caption, we can count about ten properties requiring administration, then for the relatively simple Button component, described above, which also includes the Text, there would be more than forty such properties.

Yet another difficulty of using existing visualization systems is the fact that they had initially been developed in isolation from data management systems. This isolation is a result, among other things, of the fact that in the majority of cases, a visualization system is not included in a data management system (as in the previous aspect of the present invention), but had been developed for use in miscellaneous data management systems. The natural fee for such isolation is the complexity of mutual conjugation component of two completely different systems (data management and visualization), which is achieved only through the writing of extensive programming codes.

The aforementioned problems, specific for all existing visualization systems, could be partially or completely eliminated, which would significantly lower the labor intensity of visual interface development, if we re-visit the principles of organization of a visual component system library.

If we analyze any two-dimensional graphic image of an arbitrary complexity, utilized as a user interface, it will be obvious that it could be formed by different combinations of images, created by only three graphic subjects: Text, Image and Canvas. So, the visual Button mentioned as an example before, could be implemented not by one monolith component, but by a combination of the subjects: Canvas+Text+Image. Hence, the main problem of the visualization—an extensive number of components accompanied their permanent functional incompleteness, could be successfully solved by potentially indefinite number of combinations of elementary visualization components, hereinafter referred to as Primitives. At the same time, it is important to emphasize that the actual process of forming combinations implies a connection of the parent-child type between the subjects. Each of the listed elementary graphic subjects—Primitives—has at least one unique property, with relation to which it uses an original method of graphic image creation of its own, as well as a method of implementing the user interaction. The unique property and the method of its formation by the user hereinafter will be referred to as the base property and the base method of a Primitive.

The minimal component context of a library allows, for each Primitive, to have a separate fixed visual dialog to administer its properties. Thus, since the set of Primitive properties is very limited, the dialog contains only a few visual tools for the administration. This dialog is organized, taking in consideration the requirements of ergonomics and visual simplicity, in a way that guarantees the best visual simplicity with the least user actions required to administer individual properties. To simplify the dialog accessibility even more, we should make it ‘floating’ next to the Primitive selected for the administration.

The use of a dialog based on such principles significantly increases the productivity of the visual administration process for the user interface and allows us to discontinue the more labor intensive universal property Inspector or instrumental panel that are so popular presently.

In the description of the previous aspect of the present invention it was emphasized that the visual components of an interface are effectively derivative form metadata subjects and will automatically, without the writing of any programming code, receive a declarative association with data while created as a part of a new instance of a metadata subject Representation. This association is expressed in the fact that an interface component owns an identifier of a Data-component on the data side, which allows it to receive data from the Selection for presentation and to react to the user actions translating these actions to a data-component. For the purposes of the present invention it is important to emphasize that the same association mechanism could be fully utilized for a unified association of all visual Primitive private properties with data, which also does not require any programing code writing in the process of the interface administration. In other words, each property of the system library Primitive, which could be potentially dependent on data, has a place in its structure for a Data-component identifier. Correspondingly, the managing structures for such a property contains, among others, a method to call the unified (for all the properties) metadata subject selection dialog for the creation of an association. When a required subject is selected, the indicated dialog initiates the creation of a Data-component on the data side, its inclusion in a Data-resource and returns the identifier, received when a Data-component is created, to be subsequently stored in the Primitive property.

Since many visual properties (for example, color) are used only for visual selection display in a common interface picture, there is no need to extract the value of these properties from a data management system explicitly, but a method of alternative highlighting should be used. The essence of the alternative highlighting is the use of either a main or an alternative value depending on the external managing logical value.

Respectively, the declaration of an alternative property has a complex structural composition, and, apart from the main value, includes an alternative value and a Data-component identifier. If an alternative value is set, an association with a metadata subject of a logical type is possible (and mandatory for implementation). When instances of visual components form the final display, the alternative instance property value will be used instead of the main, if the respective Data-component returns the value of True through the Selection.

It is important to emphasize that from the administration and value formation point of view, all Primitive properties could be divided into static, dynamic and alternative. The static properties have no association with metadata subjects and their values could be modified only through the unified Primitive properties administration dialog. A property would be considered dynamic if it has a direct association with the metadata subject in the form of a Data-component identifier ownership.

A two dimensional graphic interface is primarily characterized by a rectangular geometry of all incorporated instances of graphic components. Even if the screen displays some visual rounding (an oval shaped button, as an example), this is just a method of component drawing where a part of the initial rectangle is not covered by the image. As a result, all components of a system library could inherit from a common ancestor, which describes geometry with four coordinates: two for each ordinal axis. At the same time, as we will demonstrate below, a coordinate declaration has a complex structure, and each of the four coordinates could be regarded as an instance of a declarative definition of a meta-coordinate.

An immediate interaction of graphic components, inclusive of coordinates, is implemented through the system of their parent-child relationships. Furthermore, a graphic component (instance) could exist only with relation to some other instance of a graphic component. Even an assumedly independent window Form exists with relation to the common visual Scene, which is also an instance. Correspondingly, the declaration of a parent-child relationship is also defined on the level of a common ancestor for all components.

Let's review properties of specific components in more details.

The Text component is used to display arbitrary text in the form of a consecutive set of visual images of its constituent symbols. Respectively, the base property of a text primitive manipulates an information value that represents a sequence of symbolic code in a possible encoding common for the entire set, while the base method represents a traditional visual text editor.

Visually, a displayed text is characterized by static properties: Font, Font Size, number of Lines, Line spacing, Alignment, Shadowing, Font Outline, as well as by alternative properties of visual highlighting: Color, Bold, Italic, Underline, Strikeout. The base property of a Text element could be both Static (a primitive is used as an element for the interface decoration) and Dynamic. In the latter case the displayed text is characterized by an Editable property and could be either plain text or contain HTML tags.

The Image primitive is used to display an arbitrary image. Correspondingly, its base property manipulates an information value representing a raster or vector image in any memory storage format, with or without compression. The base property of an Image primitive could be static (the primitive used as a decorative interface element), alternative or dynamic. In the latter case the image is characterized by a static Editable property that would permanently allow or forbid the use of the base method for the image modification.

Visually, an image is described by static properties of Transparency and Scalability, which allows/forbids a modification of the initial size.

The base method is a visual dialog for the selection of the image source, which could be a file or device (a camera, for example).

The Canvas primitive is used to display a rectangular area consisting of two main parts: the Background area and the Border area. The Background area, in its turn, includes the Header area and the area of Enumeration. As a part of the Canvas, the Background area exists and is displayed at all times, while the use and display of the areas of Border, Caption and Enumeration is set optionally in the respective eponymous properties of administration.

Unlike the Image and the Text, the base property of the Canvas is not visual, but interactive, and consists of the ability to perceive a direct impact of the user on the visual area of the Canvas.

Correspondingly, for these purposes, the dynamic base property should be associated with an Event metadata subject, in which case the base method consists of the translation of the user action to this subject. In the absence of such association, the Canvas is not interactive anymore and will be used exclusively as a decoration interface element.

The Canvas primitive, in its visual entirety, is described by a static Transparency and a dynamic Visibility. The Transparency is set as a level of transparency of the resulting Canvas display. The Canvas Visibility allows for a situational administration of the displayed component context of the interface from the application side.

Visually, the Background area is described by an alternative color of Filling, equally or gradient distributed. A more complex drawing of the Background could be implemented by a superposition of the Image primitive. The border area visually limits the Background area on four sides and could be one of two types: graphic or linear.

A predefined and extendable set of graphic Borders allows us to implement a rounded (up to an oval) or bas-relief Canvas display. A linear Border is displayed as a continuous or interrupted line with the thickness and color set optionally. Unlike the graphic, a linear Border allows for a separate administration of each side display and could be utilized to display single lines as well as table structures. All Border properties are static, except for the color of the linear Border, which is alternative. A linear Border with zero thickness is equivalent to the border being excluded from display.

The Caption area does not have visual properties of its own and intended for the placement on its surface of child primitives, which form captions for tables and Forms. If the Caption area has no child entities, the Caption area is excluded from display.

The Enumeration area is intended for the placement on its surface of child primitives, which forms table rows as well as graphs and diagrams, and is permanently associated with the object set. The enumeration display is managed by an array of records, in which each record contains the full set of information values of the child Enumeration primitive.

The actual display is formed by the Enumeration line by line, in the direction of the assigned Enumeration vector; thus for each record of the managing array the Enumeration initiates the display of child primitives in the remaining free space of the area, passing the content of the record for the selection of information values. Correspondingly, the child primitives are grouped on the surface of the Enumeration area in such a manner that their totality forms a visual line of the Enumeration.

The array of records managing the Enumeration is essentially a ‘selection window’ from the associated set. The fixed size of the array in records is calculated automatically, based on the relation between the size of the Enumeration area and the enumeration line in the direction of the Vector in such a manner that the area space if fully filled in. To change the location of the “selection widow” in the associated set based on the user navigational events, the Enumeration provides an interactivity of its own.

For the purposes of the present invention we should emphasize that the presence of an interactive behavior of the Enumeration, the requirement for an association with the set as well as the convenience of a primitive creation as a Representation of a metadata subject set aspect, enables us to separate the innate Canvas enumeration capacity into a separate primitive, referred to as an Enum, and formed by a direct inheritance from the Canvas.

It is important to note that unlike the Image and Text primitives, the Canvas primitive is allowed to place on its surface child primitives, while automatically forming a parent-child relationship, which becomes the base for the implementation of potentially infinite number of primitive combinations. Thus the child primitives interact by coordinates with the parent Canvas and are subject to such general Canvas properties as Transparency and Visibility.

An interaction by coordinates in the parent-child relationships is expressed by a limiting rule: “a child cannot leave the boundaries of the parent area”. When the primitive geometry is changed, this rule manifests itself explicitly, by forbidding the movement of a child primitive beyond the area of the parent, as well as by respectively restricting size reduction for the parent primitive.

When displayed, this rule manifests itself in such a manner that the part of a child primitive extended beyond the boundaries of the parent is cut off. To overcome this limitation and achieve the more flexible administration of child primitive display, the Canvas has static properties of Expandability and Scroll, which act separately for each axis of X and Y and are optionally administered by setting eponymous flags.

If the selected axis of coordinates includes the Expandability, then the child primitives could modify the size of Canvas along this axis (towards an increase) by a value sufficient for their full display; thus the mentioned modification could be limited by the static size of a more senior parent Canvas. If the selected axis of coordinates includes the Scroll, then the size of the Canvas surface for this axis is considered effectively infinite, and the acting area of the Background with fixed coordinates becomes a “window” for this surface.

A the same time, to access the display of child primitives extending beyond the visible window, the Canvas automatically includes a visual tool for the administration of the window location; the tool is aligned to one of the same axis sides of the Background and is known as a Scroll bar. The Expandability and Scroll properties are mutually exclusive for the common coordinate axis. The Enum primitive, derivative from the Canvas, has the property of Scroll bar (on the same axis as the Enumeration vector) included permanently.

For the purposes of the present invention it is important to note that, when a certain condition is satisfied, any of the coordinates of any primitive could be associated with the external source of the value—class Attribute that control information values of a numerical type, including values of type date-time. This association between a coordinate and an Attribute allows us to build graphs, diagrams, as well as to visually anchor a primitive display to a specific point on map or scheme.

A mandatory requirement for the creation of an association between a primitive coordinate and an Attribute is the availability of the method of the conversion of an information numeric value into a display coordinate and back. Such a method exposes, for its child primitives, the Canvas primitive as one of their own actualized properties of Scale or Map. Each of these properties, when actualized, will contain a pointer to an eponymous non visual component that owns the respective image as well as some numeric values, corresponding to the borders of this image on the coordinate axis.

The availability of the mentioned border values enables a child primitive, by the use of simple proportion, to convert the numeric value of a coordinate into the value of a display coordinate with respect to the parent Canvas, subsequently used by the primitive to form its final display on the surface of the Canvas.

The Scale property uses the content of an associated component as a visual decoration and a calculation base when Graphs and Diagrams are implemented. Thus the actual display is effected by the child primitives of Text and Image, using an Enumeration property when necessary. The Scale property is used by the Canvas primitive with respect to the border area and is assigned separately for each side. The image borrowed from the Scale component substitutes (with image scaling if required) the graphic display of a border side, while the border values are applied to the same axis of coordinates.

It is obvious that the Scale property could be assigned simultaneously only for two mutually orthogonal sides of the Canvas Border area. The Map property is used by the Canvas primitive with respect to the background area.

An image, borrowed from the Map component, substitutes (with an image scaling if required) the filling of the Background area, while the border values are applied to the respective coordinate axis. Thus we implement the visual and calculation base for a schematic or map positioning of the child primitives display, with or without the Enumeration. At the same time it is obvious that a simultaneous use of the Scale and Map properties is not possible.

In the most general case the auxiliary components of Scale and Map could be grouped into homogeneous collections. The purpose of such a union is the use of the collection for a dynamic change of the scale for a resulting Graph or Diagram. Thus the actual Scale and Map components could represent data objects, derivative from a service class of a data management system, while the Scale and Map properties of a Canvas primitive could posses a unified association with this form of component storage.

It is worth pointing out that such a property of the Enumeration as the Vector indicates the direction for the placement of derivative displays of child components, and, in the majority of the cases, by default, this Vector is directed upside down. However in the most general case, the Enumeration Vector could have any direction and, furthermore, could setup not only a linear, but also a radial angular mode of formation for the final display. The last consideration allows us to use the Enumeration not only for the creation of linear and tabular, but also circle Diagrams.

The set of primitives and their private properties, reviewed above, in conjunction with the method of unified data management allows us to create the most complex visual and non visual user interface without writing any programming code, by using exclusively efficient and visually accessible methods of direct visual development.

At the same time it is important to emphasize that for the purposes of the present invention we reviewed only the most significant characteristics of primitives and only the most important types of their behavior. However, various modifications of the behavior described above could be effected without deviating from the essence and the content of the present invention, which is limited only by the formula of the invention and its equivalents.

1. A method of unified association between a graphic user interface and data in a programmatically implemented computer data management system, inclusive of at least a processor, memory and a graphic information display unit, where machine-readable data are instances, derivative from uniquely identified machine-readable metadata subjects, such as abstract conceptual entitles and their private characteristics, inclusive of characteristics of the conceptual entities relationships, while a graphic user interface, isolated from data, is formed by instances of unified visual components, with an identifying feature being the fact that a multi-window graphic interface is implemented without a program code writing, by a navigational combination of instances of native forms of metadata subject visual representation; while a new representation instance is created by a simple choice in a dialog of an acting metadata subject or unified subject event.

2. The method according to claim 1, wherein the mentioned representation is associated with the type of subject metadata and is a declarative subject of a data management system, including but not limited to, an instance of a unified non-visual component, referred to as a data-component, as well as a model set of visual component instances, which together forming a visual image of representation.

3. The method according to claim 2, wherein the mentioned representation instance is created by the representation of subject metadata, selected in a dialog, and includes but not limited to: on the data side—a uniquely identifiable data-component instance; on the graphic interface side—a set of visual component instances, formed by copying of a parent representation model set, where the mentioned data-component instance owns an identifier of the mentioned metadata subject, which is used to extract or store data, derivative from the mentioned subject, by the methods of the mentioned subject, wherein the mentioned visual component instances owns an identifier of data-component instance, which is used to receive data from the mentioned instance of the date-component, or to pass user events and entered data to the mentioned instance.

4. The method according to claim 1, wherein the mentioned interface window is an independent named representation of a separate conceptual entity, and contains a combination of representations of characteristics and events of this entity, where each separate metadata conceptual entity has an arbitrary set of proper named representations.

5. The method according to claim 1, wherein the mentioned navigational combination is implemented by, including but not limited to, a selection of relationship characteristic; thus a representation instance is created that is unified in accordance with the quantitative power of the relationship and associated with a target relationship entity.

6. The method according to claim 1, wherein the mentioned graphic interface is implemented in 3D virtual space with the use of 3D visual components.

7. A visual data management system in a computing environment, inclusive of at least a processor, memory and a graphic information display unit, where machine-readable data are instances, derivative from uniquely identified machine-readable metadata subjects, such as abstract conceptual entitles and their private characteristics, while a graphic user interface, isolated from data, is formed by instances of unified visual components, with an identifying feature being the fact that a multi-window graphic user interface with the functions of direct management of data formed by a combination of instances the native forms of visual representation of the mentioned metadata subjects, every one of which includes: on the data side—at least one instance of a unified non-visual component, referred to as a data-component, which owns a metadata subject identifier; on the graphic interface side—at least one instance of the mentioned visual component, which owns a data-component identifier, while each window of the mentioned multi-window interface is an independent named representation of a separate conceptual entity and contains a combination of characteristic and event representations of this entity.

8. The system according to claim 7, wherein the mentioned representation of a conceptual entity is a machine-readable instance, referred to as an interface resource, and derivative from a service metadata entity, which includes at least three characteristics, while a data component instance set of the mentioned interface window is bound by a parent-child relationship and, in totality, form a first tree-like data structure, in which each separate instance is uniquely identifiable, while a visual component instance set of the mentioned interface window is bound by a parent-child relationship and, in totality, forms a second tree-like data structure, while the first and the second data structures in a serialized form to form the values of the first and the second characteristics, and the name of the mentioned representation forms the value of the third characteristic of the service entity in the mentioned resource.

9. The system according to claim 8, wherein the mentioned interface resource is associated with a metadata conceptual entity in such a manner that each separate conceptual entity has an arbitrary set of proper named interface resources, which form a collection of entity resources.

10. The system according to claim 8, wherein the value of the first characteristic of the mentioned resource are used on the data side in such a manner that the mentioned data-component instances use the methods of associated subjects for the extraction of their derivative data values, which are stored in a data structure, referred to as a Selection, in such a manner that each value is uniquely identified by an identifier of the respective data-component instance, while the value of the second characteristic of the mentioned resource is used on the graphic interface side in such a manner that visual components extract values from the Selection, using an identifier of the associate data-component, while the mentioned Selection is passed from the data side to the graphic interface side on request, while the mentioned data side and the mentioned graphic interface side exist on, but not limited to, different computers, interacting through a data net.

11. A method for the implementation of visual user interfaces in a computing environment, inclusive of at least a processor, memory and graphic display unit, where a graphic image is formed by the dynamically programming method with instances of specialized visual components, linked by a parent-child relationship, where each instance display itself on the surface of the image, provided by its parent instance, with an identifying feature being the fact that a multi-window graphic interface of arbitrary complexity is implemented without writing any programming code, by a simple combination of instances, derivative from the smallest possible set, containing three atomic visual components, referred to as primitives, where each of the primitives has at least one unique property, referred to as the base property, lacking in all other primitives; and the method of user entry for this property is referred to as the base method, where each of the primitives has at least one proper unique visual dialog for the administration of its private properties, where the primitive properties have a unified method of association with data sources, external with relation to the graphic interface.

12. The method according to claim 11, wherein in a set of primitive instances, forming a graphic interface, the administration of private properties with the respective dialog display, at any given time, is executed only for a specific instance.

13. The method according to claim 11, wherein the mentioned smallest possible set includes but is not limited to a Text primitive, the instances of which are used for the visualization of an arbitrary text value with the number of lines, font, font size, color and all other methods of text symbol visual representation indicated in individual properties, while the mentioned base property contains either statically stored text or a pointer to an external source of a dynamic text value, and the base method is represented by a visual text editor.

14. The method according to claim 11, wherein the mentioned smallest set includes but is not limited to an Image primitive, the instances of which are used for the visualization of an arbitrary image by the method of scaling, indicated in the private properties, while the actual image could exist in any known format, and the mentioned base property contains either a statically stored image or a pointer to an external source of a dynamic image, and the base method is represented by a visual dialog of the image source selection.

15. The method according to claim 11, wherein the mentioned smallest set includes but is not limited to a Canvas primitive, the instances of which are used for the visualization of a rectangular area, and processing of the user events in this area, as well as the placement in this area of child primitive instances, while the mentioned area consists of two parts: Background area and Border area, while the mentioned base property optionally contains a pointer to the external event interpreter; and the base method translates a user event to the mentioned interpreter; and thus, in the mentioned Background area, mutually independent Caption and Enumeration properties optionally highlight two special internal eponymous areas, and thus the Caption area is used to visualize table and separate form captions, while the Enumeration area is used to visualize the content of tables, diagrams and graphs, and the property Enumeration includes association with data, having the form of an enumerable set.

16. The method according to claim 11, wherein the mentioned smallest set of visual components is expanded by the creation, on the base of a primitive-ancestor Canvas, of a specialized primitive-descendent Enum; thus the Enumeration property, inherited from the ancestor, becomes the base property of the descendent.

17. The method according to claim 15, wherein the mentioned Canvas primitive has Scale and Map properties, the use of which enables its child primitives to set the coordinate properties association with data sources, external with relation to the graphic interface, and to convert the values received from outside into parent Canvas coordinates.

18. The method according to claim 11, wherein the mentioned combination of component instances is effected in such a manner that, on the visual surface of an existing instance, a group of few primitive instances is created, linked with a parent-child relationship, where the mentioned group of instances is described by a commonly used template, and in totality forms a visual component of an arbitrary functional complexity, where the mentioned template is created based on an existing group of instances.

19. A machine-readable information carrier, containing commands, which, while executed by a processor, triggers the computer execution of a routine, which includes the creation of multi-window user interface without writing of a programming code, by navigational combination of visual metadata subject representation native forms, while a new representation instance is created by a simple selection in a dialog of the acting metadata subject or unified subject event, while the mentioned representation instance includes: on the data side—at least one instance of a unified non-visual data-component, which owns an identifier of metadata subject; on the graphic interface side—at least one instance of a visual component, which owns the identifier of the mentioned data-component, while each window of the mentioned multi-window interface is an independent named representation of a separate conceptual entity and contains a combination of characteristic and event representation of this entity.
